(19) United States
(12) Patent Application Publication
(10) Pub. No.: US 2013/0119226 A1
(43) Pub. Date: May 16, 2013

(54) Reconfigurable Motor Mount

(71) Applicant: GENERAL KINEMATICS CORPORATION, Crystal Lake, IL (US)

(72) Inventors: Edward Charles Steffes, JR., Woodstock, IL (US); Paul Musschoot, Marengo, IL (US)

(73) Assignee: GENERAL KINEMATICS CORPORATION, Crystal Lake, IL (US)

(21) Appl. No.: 13/677,234

(22) Filed: Nov. 14, 2012

Related U.S. Application Data
(60) Provisional application No. 61/559,786, filed on Nov. 15, 2011.

(51) Int. Cl. H02K 5/04

(52) U.S. Cl. CPC H02K 5/04
USPC 248/645

(57) ABSTRACT

A motor mount is reconfigurable between at least a first configuration adapted to accept a first arrangement of fasteners and a second configuration adapted to accept a second arrangement of fasteners, the first and second arrangements of fasteners being different from each other.

### BACKGROUND

This patent is directed to a motor mount, and, in particular, to a reconfigurable motor mount.

### SUMMARY

According to one aspect of the present disclosure, a motor mount is provided that is reconfigurable between at least a first configuration adapted to accept a first arrangement of fasteners and a second configuration adapted to accept a second arrangement of fasteners, the first and second arrangements of fasteners being different from each other.

According to another aspect of the present disclosure, a reconfigurable motor mount includes at least one connection point that has at least a first configuration adapted to accept a first arrangement of fasteners and a second configuration adapted to accept a second arrangement of fasteners. The first and second arrangements of fasteners are different from each other, for example relative to a longitudinal or a transverse distance.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a bottom view of a motor incorporating a reconfigurable motor mount having a plurality of reconfigurable feet according to an embodiment of the present disclosure;

FIG. 2 is a top perspective view of an invertible insert used with one of the reconfigurable feet of the reconfigurable motor mount of FIG. 1 according to an embodiment of the present disclosure;

FIG. 3 is a bottom perspective view of the insert illustrated in FIG. 2;

FIG. 4 is a plan view of the insert illustrated in FIG. 2;

FIG. 5 is a side view of the insert illustrated in FIG. 2;

FIG. 6 is a frontal view of the insert illustrated in FIG. 2;

FIG. 7 is a sectional view of the motor mount of FIG. 1, illustrating one of the reconfigurable feet in a first configuration;

FIG. 8 is a bottom view of the motor mount as configured in FIG. 7;

FIG. 9 is a sectional view of FIG. 1, the reconfigurable foot in a second configuration;

FIG. 10 is a bottom view of the motor mount as configured in FIG. 9;

FIG. 11 is a top perspective view of an alternative insert according to the present disclosure;

FIG. 12 is a plan view of the insert illustrated in FIG. 11; and

FIG. 12 is a frontal view of the insert illustrated in FIG. 11.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

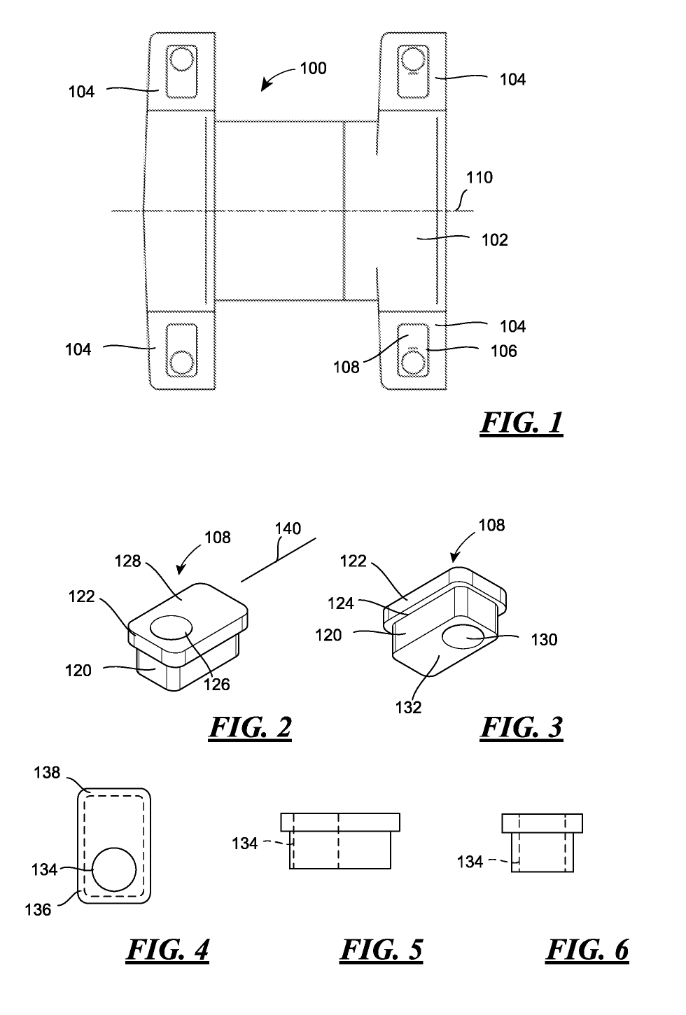

FIG. 1 illustrates a motor 100 according to the present disclosure. The motor 100 includes a motor mount 102 that is reconfigurable between at least a first configuration and a second configuration. In fact, the mount 102 may be reconfigurable between a plurality of configurations, in either a discrete or a continuous fashion.

According to certain embodiments of the present disclosure, the motor mount 102 may have one or more (i.e., at least one) reconfigurable connections or connection points by or at which the mount 102 is connected to a frame or a vibratory apparatus, such as a vibratory conveyor or feeder. The number of connections or connection points may vary between embodiments according to the present disclosure. For example, according to certain embodiments, four connections or connection points may be used, while according to other embodiments six connections or connection points may be used. Furthermore, the pattern of these connections or connection points may vary between embodiments, as explained in greater detail below.

According to the embodiment illustrated in FIG. 1, the motor mount 102 includes a plurality of reconfigurable connection points disposed about the motor mount 102. In particular, there are four connection points disposed about the periphery of the mount 102. Each connection point is defined on a separate one of four motor mount feet 104, with two feet 104 arranged on each side of the mount 102 and at each end of the mount 102. Each of the motor mount feet 104 is individually and separately reconfigurable. According to other embodiments, the mount 102 may include a single foot, or pad, arranged on each side of the mount, the foot or pad (or the connection points thereof) being individually and separately reconfigurable.

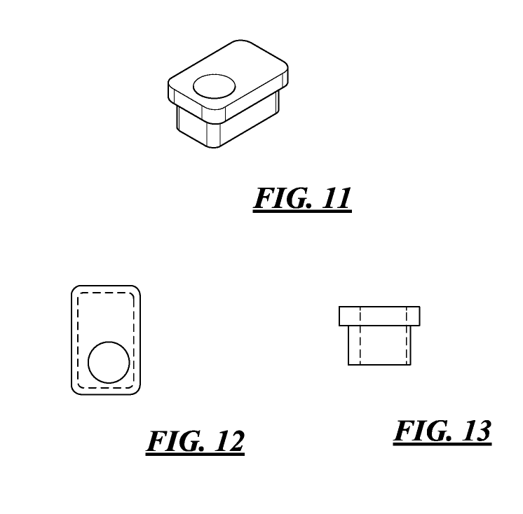

According to an embodiment of the present disclosure, each of the reconfigurable connection points disposed at one of the motor mount feet 104 includes a cavity or recess 106 in which is disposed an invertible insert 108. The insert 108 will be described in greater detail with reference to FIGS. 2-6, and alternatively FIGS. 11-13. By varying the orientation of the insert 108 within the cavity or recess 106, the connection points may be reconfigured between a first configuration and a second configuration.

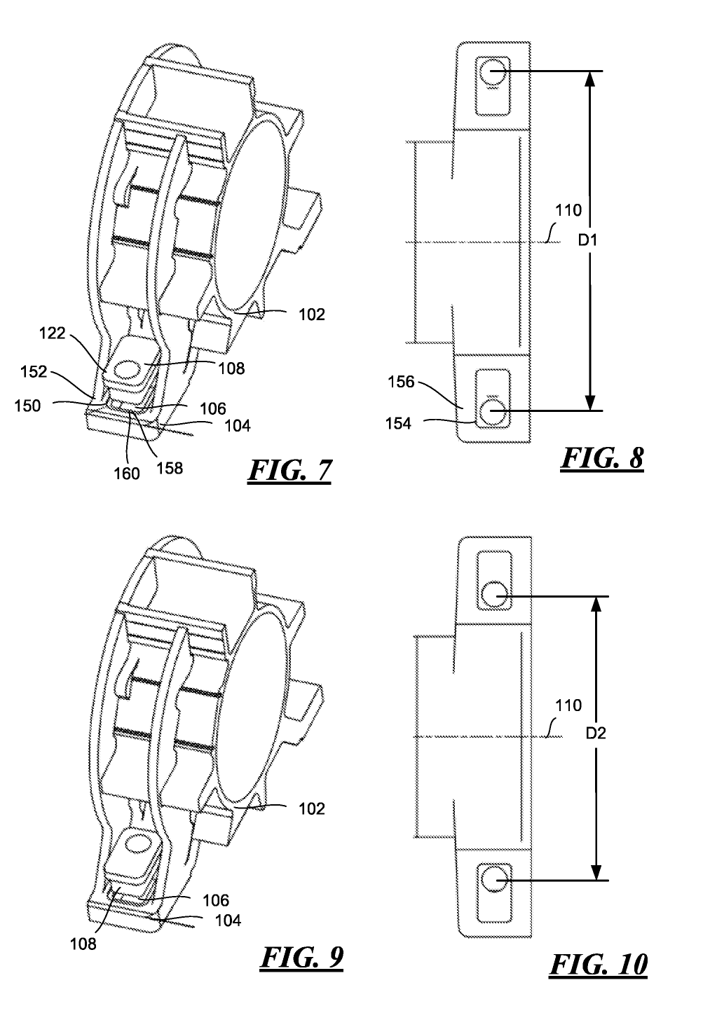

The first and second configurations of the motor mount 102 are illustrated in FIGS. 7-10. In particular, FIGS. 7 and 8 illustrate a first configuration of the connection points or the motor mount feet 104, capable of accepting or adapted to accept a first arrangement of fasteners (such as bolts, for example) connected to a frame wherein the fasteners are separated by a first distance D1 in a transverse direction relative to an longitudinal axis 110 (see FIG. 8). On the other hand, FIGS. 9 and 10 illustrate a second configuration of the connection points or the motor mount feet 104, capable of accepting or adapted to accept a second arrangement of fasteners connected to a frame wherein the fasteners are separated by a second distance D2 in a transverse direction relative to the longitudinal axis 110.

As will be recognized from the drawings (particularly FIG. 1), the arrangement of fasteners accommodated by the first configuration of motor mount feet 104 may be separated a distance identical to that accommodated by the second configuration of motor mount feet 104 in the longitudinal direction (i.e., along an axis parallel to the axis 110). Alternatively, the longitudinal distance separating the fasteners accommodated by the feet 102 in the first configuration may be different from the distance between the fasteners accommodated by the second configuration of motor mount feet 104. In fact, according to other embodiments of the present disclosure, the arrangement of fasteners accommodated by the first and second configurations of motor mount feet 104 may be separated by the same distance in the transverse direction relative to the longitudinal axis 110, but may vary as to their separation in the longitudinal direction. As a consequence, the reconfigurable motor mount 102 according to the present disclosure is capable of addressing a number of different possible reconfigurations, of which the disclosed configurations are but simply examples.

Turning now to FIGS. 2-6, an insert 108 according to the present disclosure is illustrated therein. This insert 108 is capable of being used with reconfigurable motor mount 102 illustrated in FIG. 1, as better explained with reference to FIGS. 7-10. It will be understood that the insert 108 is simply an exemplary embodiment of the present disclosure, and not is in is not intended to limit the insert relative to size, shape or dimensions. For example, while the insert 108 illustrated in FIGS. 2-6 has a generally rectangular geometry, it will be recognized that a similar insert could be formed with cylindrical geometry instead.

As illustrated in FIG. 2, the insert 108 includes a body 120 from which depends a flange, rim or lip 122. As a consequence, a shoulder 124 is formed at the junction of the body 120 and the flange 122. The purpose of the flange 122 and the shoulder 124 will be explained in greater detail with reference to FIGS. 7-10 below.

In addition, the insert 108 includes an opening or aperture 126 in a top surface 128 (see, e.g., FIG. 2) and an opening or aperture 130 in a bottom surface 132 (see, e.g., FIG. 3). The aperture 126 and the aperture 130 are connected by a passage 134 (see FIGS. 5 and 6). The apertures 126, 130 and the passage 134 may be formed in the body 120 of the insert 108 in a number of different fashions, including molding and cutting. The passage 134 is shaped to accept a fastener therethrough so as to secure the motor mount 102 to a frame from which the fastener depends. As illustrated, the insert 108 has first and second ends 136, 138, and the passage 134 is disposed closer to the first end 136 than the second end 138 of the insert 108.

As also will be recognized with reference to FIGS. 2, 4, and 6, the passage 134 is centered along a longitudinal axis 140 of the insert 108 (i.e., relative to a rectangular geometry, the axis 140 is aligned with or parallel to the longer sides of the insert 108). Alternatively, the passage 134 may be offset in a transverse direction relative to the longitudinal axis 140. See FIGS. 11-13. If the passage 134 is offset, then the insert 108 is capable of accommodating not only differences in the transverse distance between the fasteners, but longitudinal distances between the fasteners. This will be readily recognized by comparing the insert illustrated in FIGS. 11-13 with than of FIGS. 2-6.

As illustrated in FIGS. 7 and 9, the insert 108 may be disposed within the cavity 106 in the foot 104. In particular, the cavity 106 may depend through the foot 104 from an aperture 150 on an upper surface 152 to an aperture 154 on a lower surface 156 (see FIGS. 7 and 8). The cavity 106 may also have an inwardly directed rim 158 that defines a shoulder 160. The flange 122 of the insert 108 cooperates with the rim 158 of the cavity 106 to properly seat the insert 108 within the cavity 106. With the insert 108 fully seated within the cavity 106, the shoulder 124 of the insert 108 abuts the shoulder 160 defined by the rim 158 within the cavity 106. It will be recognized that other methods for ensuring the proper seating of the insert 10 within the cavity 106 may be substituted for that described herein.

In use, the insert 108 may be oriented either as illustrated in FIGS. 7 and 8, or as illustrated in FIGS. 9 and 10. With the insert 108 oriented as illustrated in FIGS. 7 and 8 (i.e., with the insert 108 disposed in the cavity 106 with the first end 136 of the insert 108 aligned with a first end of the cavity 106), a fastener pattern with a transverse distance of D1 between the fasteners may be accommodated. This may be referred to as the first configuration of the reconfigurable motor mount 102. With the insert 108 oriented as illustrated in FIGS. 9 and 10 (i.e., with the insert 108 disposed in the cavity 106 with the second end 138 of the insert 108 aligned with a first end of the cavity 106), a fastener pattern with a transverse distance of D2 between the fasteners may be accommodated. This may be referred to as the second configuration of the reconfigurable motor mount 102. Because of the rectangular nature of the insert 108 and the cavity 106, only two configurations may be accommodated by the illustrated embodiment, although it will be recognized according to the variations described above that other embodiments may accommodate a variety of other patterns.

What is claimed is:

1. A reconfigurable motor mount comprising:
at least one connection point that has at least a first configuration adapted to accept a first arrangement of fasteners and a second configuration adapted to accept a second arrangement of fasteners, the first and second arrangements of fasteners being different from each other.

2. The reconfigurable motor mount according to claim 1, wherein the at least one connection point comprises a plurality of connection points, and the plurality of connection points are disposed about the periphery of the motor mount.

3. The reconfigurable motor mount according to claim 1, wherein the motor mount has at least one motor mount foot, and the at least one connection point is defined on the at least one motor mount foot.

4. The reconfigurable motor mount according to claim 3, wherein the at least one connection point comprises a recess formed in the at least one motor mount foot and an invertible insert disposed in the recess, the invertible insert having a first orientation corresponding to the first configuration and a second orientation corresponding to the second configuration.

5. The reconfigurable motor mount according to claim 4, wherein the at least one connection point comprises two connection points disposed on either side of a longitudinal axis of the motor mount, the invertible inserts on either side disposed in the respective recesses in a first orientation to receive two fasteners separated by a first transverse distance and in a second orientation to receive two fasteners separated by a second transverse distance.

6. The reconfigurable motor mount according to claim 5, wherein:
the insert comprises a passage connecting a first opening in a top surface of the insert and a second opening in a bottom surface of the insert, the insert having a longitudinal axis and the passage centered along the longitudinal axis, and
the recess has a first end and a second end, and the insert has a first end and a second end in the longitudinal direction, the passage disposed closer to the first end than the second end of the insert, with the insert disposed in the recess with the first end of the insert aligned with the first end of the recess in the first orientation and the insert disposed in the recess with the second end of the insert aligned with the first end of the recess in the second orientation.

7. The reconfigurable motor mount according to claim 4, wherein the at least one connection point comprises two connection points disposed on either end of the motor mount, the invertible inserts on either end disposed in the recesses in a first orientation to receive two fasteners separated by a first longitudinal distance and in a second orientation to receive two fasteners separated by a second longitudinal distance.

8. The reconfigurable motor mount according to claim 5, wherein the at least one connection point comprises two connection points disposed on either end of the motor mount, the invertible inserts on either end disposed in the recesses in a first orientation to receive two fasteners separated by a first longitudinal distance and in a second orientation to receive two fasteners separated by a second longitudinal distance.

9. The reconfigurable motor mount according to claim 8, wherein:
the insert comprises a passage connecting a first opening in a top surface of the insert and a second opening in a bottom surface of the insert, the insert having a longitudinal axis and the passage offset in a transverse direction relative to the longitudinal axis, and
the recess has a first end and a second end, and the insert has a first end and a second end in the longitudinal direction, the passage disposed closer to the first end than the second end of the insert, with the insert disposed in the recess with the first end of the insert aligned with the first end of the recess in the first orientation and the insert disposed in the recess with the second end of the insert aligned with the first end of the recess in the second orientation.

10. The reconfigurable motor mount according to claim 4, wherein recess has an inwardly directed rim that defines a recess shoulder, and the invertible insert includes a body and a flange depending from the body to define an insert shoulder at a junction of the body and the flange, the flange cooperating with the rim to seat the insert within the recess with the insert shoulder abutting the recess shoulder.

11. The reconfigurable motor mount according to claim 10, wherein the insert comprises a passage connecting a first opening in a top surface of the insert and a second opening in a bottom surface of the insert, the insert having a longitudinal axis and the passage centered along the longitudinal axis.

12. The reconfigurable motor mount according to claim 11, wherein the recess has a first end and a second end, and the insert has a first end and a second end in the longitudinal direction, the passage disposed closer to the first end than the second end of the insert, with the insert disposed in the recess with the first end of the insert aligned with the first end of the recess in the first orientation and the insert disposed in the recess with the second end of the insert aligned with the first end of the recess in the second orientation.

13. The reconfigurable motor mount according to claim 10, wherein the insert comprises a passage connecting a first opening in a top surface of the insert and a second opening in a bottom surface of the insert, the insert having a longitudinal axis and the passage offset in a transverse direction relative to the longitudinal axis.

14. The reconfigurable motor mount according to claim 13, wherein the recess has a first end and a second end, and the insert has a first end and a second end in the longitudinal direction, the passage disposed closer to the first end than the second end of the insert, with the insert disposed in the recess with the first end of the insert aligned with the first end of the recess in the first orientation and the insert disposed in the recess with the second end of the insert aligned with the first end of the recess in the second orientation.

15. The reconfigurable motor mount according to claim 10, wherein the insert has a rectangular geometry, with the longitudinal axis of the insert aligned with the longer sides.

16. The reconfigurable motor mount according to claim 15, wherein the at least one connection point comprises a plurality of connection points, and the plurality of connection points are disposed about the periphery of the motor mount.

17. A motor mount that is reconfigurable between at least a first configuration adapted to accept a first arrangement of fasteners and a second configuration adapted to accept a second arrangement of fasteners, the first and second arrangements of fasteners being different from each other.
